(19) United States
(12) Patent Application Publication
(10) Pub. No.: US 2005/0281643 A1
(43) Pub. Date: Dec. 22, 2005

(54) Conveyor system for loading hopper cars of dump train and associated methods

(76) Inventors: Christopher M. Villar, Georgetown, TX (US); Steven C. Orrell, Georgetown, TX (US); Thomas Schwertner, Jarrell, TX (US); Clarence P. Wilganowski, Georgetown, TX (US); John B. Messer JR., Belton, TX (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 11/069,782

(22) Filed: Mar. 1, 2005

Related U.S. Application Data
(60) Provisional application No. 60/548,984, filed on Mar. 1, 2004.

(51) Int. Cl. B65F 9/00

(52) U.S. Cl. 414/339

(57) ABSTRACT

A hopper car of a dump train for transporting material includes a hopper and a conveyor for loading the hopper with material. The loading conveyor includes a frame, a first pulley, a second pulley, and a continuous belt. The frame is attached to the car above the hopper. The first pulley is attached at one end of the frame adjacent an end of the hopper car. The first pulley has a motor positioned therein such that when the motor is operated the first pulley is rotated. The second pulley is attached at another end of the frame adjacent another end of the hopper car. The continuous belt is positioned on the first and second pulleys such that rotation of the first motorized pulley moves the continuous belt around the frame. A plow assembly is positioned on the frame and is operable to screed material off the continuous belt and into the hopper. The plow assembly includes a rotatable rod attached to the frame and includes a plow attached to the rotatable rod by an arm and a joint. Rotation of the rod raises or lowers the plow relative to the continuous belt. The plow assembly can be operated manually by a lever or can be operated hydraulically by a hydraulic actuator. The hopper car can also include a gate and a second conveyor for unloading the hopper. The gate can be mounted at an open bottom of the hopper and can be movable between opened and closed positions for discharging material from the hopper. The second conveyor is used for unloading the hopper and is positioned underneath the gate for carrying the discharged material along the dump train.

This application claims the benefit of U.S. Provisional Application No. 60/548,984 filed Mar. 1, 2004.

### FIELD OF THE INVENTION

The subject matter of the present disclosure generally relates to a conveyor system and more particularly relates to a conveyor system for loading the spoils from an undercutter to hopper cars of a dump train.

### BACKGROUND OF THE INVENTION

Railroads are generally constructed on a base layer of compacted, crushed stone material. A layer of gravel ballast rests on top of this stone layer. Wooden crossties are laid in and on this ballast layer, and two parallel steel rails are attached to the crossties. The ballast layer serves several purposes. The ballast layer cushions the loads created by rail traffic and stabilizes the track to maintain rail alignment and proper curvature. Furthermore, the voids between the gravel in the ballast layer provide a path for moisture to drain away from the track. Over time, however, the effects of rain, freeze and thaw cycles, the crushing of ballast due to traffic, and the accumulation of dirt and debris combine to foul the ballast layer. Ultimately, sufficient fouling of the layer inhibits drainage and causes moisture to accumulate. Rapid deterioration of the wooden ties in the ballast layer then begins once moisture accumulates.

As part of their regular maintenance procedures, railroads use undercutters and shoulder cleaners to clean the ballast layer. These machines travel slowly (½ to 1 mph) along the rail track and remove the ballast layer completely. When undercutters are used, the removed material goes through a screening process where the good ballast is separated from debris. The good ballast is then replaced on the track, and the debris is discarded via a boom. This boom can discard the material directly ahead of the machine or to either side of the track.

The current practice is to discard the material in the right-of-way adjacent the track wherever possible. Maximum production from the undercutters can be achieved in this way by discarding the material in the right-of-way. However, there are several serious drawbacks to the practice of discarding the material in the right-of-way. Primarily, discarding the material in the right-of-way adjacent to the track undermines the proper drainage of the track that is being restored. Furthermore, leaving windrows of dirt and other debris in the right-of-way create environmental and aesthetic concerns. Lastly, there are areas where it is physically impossible to discard material anywhere but directly ahead of the undercutter. An example of such an area would be a tunnel. Where it is impractical or impossible to discard the spoils from the undercutters to the sides of the track, the general practice is to load the spoils in an open topped container car adjacent the undercutter on the track. In practice, each car can be loaded with approximately 50-tons of material before the car must be switched out and an empty car brought in its place. This process of switching cars is time consuming and drastically slows the undercutting process. A typical undercutter can produce 400-tons of spoils per hour. Therefore, eight container cars must be switched in and out to complete one hour of actual production. As a result, it is not unusual for an undercutter to only actually work for one hour out of an eight-hour day.

Conveyors for railcars are known in the art. For example, the following U.S. patents disclose various conveyors for railcars: U.S. Pat. Nos. 1,920,500; 2,194,144; 2,457,267; 2,724,515; 2,873,866; 2,876,915; 3,167,193; 3,355,041; 3,842,994; 4,213,525; 4,576,538; 4,923,355; 5,099,766; 5,131,798; and 5,197,845. The following foreign patents also disclose various conveyors for railcars: DE 533,304; DE 1,481,286; and CH 609,622.

The subject matter of the present disclosure is directed to overcoming, or at least reducing the effects of, one or more of the problems set forth above.

### SUMMARY OF THE DISCLOSURE

A hopper car of a dump train for transporting material includes a hopper and a conveyor for loading the hopper with material. In one implementation, the conveyor can be used to load the spoils from an undercutter. The loading conveyor includes a frame, a first pulley, a second pulley, and a continuous belt. The frame is attached to the car above the hopper. The first pulley is attached at one end of the frame adjacent to an end of the hopper car. The first pulley has a motor positioned therein such that when the motor is operated the first pulley is rotated. The second pulley is attached at another end of the frame adjacent another end of the hopper car. The continuous belt is positioned on the first and second pulleys such that rotation of the first motorized pulley moves the continuous belt around the frame.

The frame of the conveyor is positioned at an angle relative to the top of the hopper car. Thus, a first end of the conveyor is positioned higher than an end of an adjacent conveyor, and a second end of the conveyor is positioned lower than an end of another adjacent conveyor. In this way, the material can be transferred between individual conveyors mounted on a plurality of hopper cars of the dump train. The frame preferably has first and second parallel C-channels attached to the hopper. The first, motorized pulley is preferably a Rollerdrive manufactured by Interroll of Wilmington, N.C. The conveyer preferably has a plurality of idle rollers attached along the length of the frame for supporting the continuous belt.

A plow assembly is positioned on the frame and is operable to screed material off the continuous belt and into the hopper. The plow assembly includes a rotatable rod attached to the frame and includes a plow attached to the rotatable rod by an arm and a joint. The plow has first and second wings. Rotation of the rod raises or lowers the plow relative to the continuous belt. The plow assembly can be operated manually by a lever, can be operated hydraulically by a hydraulic actuator, or can be operated pneumatically by a pneumatic actuator. The plow assembly also includes a base plate attached to the frame and positioned beneath the plow. The base plate preferably has angled sides to facilitate falling of material from the continuous belt to the hopper.

The hopper car can also include a gate and a second conveyor for unloading the hopper. The gate can be mounted at an open bottom of the hopper and can be movable between opened and closed positions for discharging material from the hopper. The second conveyor is used for unloading the hopper and is positioned underneath the gate for carrying the discharged material along the dump train.

A plurality of hopper cars of a dump train can be loaded with material using the disclosed conveyor and plow assembly. During loading, the material is conveyed along the disclosed conveyors individually mounted atop the hopper cars of the dump train. The material is transferred between the individual conveyors and hopper cars. Each of the conveyors is individually powered by a separate motor. The disclosed plow assemblies on the hopper cars can then be used to screed the material from the conveyor at a selected location of the dump train and to individually fill the hoppers of the cars.

Each plow assembly can be selectively operated between a raised position and a lowered position. In the raised position, the material traveling on the conveyor can pass under the plow and travel to another hopper or car on the dump train. In the lowered position, the plow screeds the material of either side of the conveyor into the hopper below. The plow assemblies can be raised and lowered relative to the conveyors by manually operating levers on the plows. In an alternative embodiment, the plow assemblies can be raised and lowered relative to the conveyors by hydraulic actuators coupled to the plows. The hopper cars of the dump train can be emptied of material by selectively operating gates mounted at open bottoms of the hoppers and conveying the emptied material along a continuous conveyor mounted underneath the hoppers of the dump train.

The foregoing summary is not intended to summarize each potential embodiment or every aspect of the present disclosure.

### BRIEF DESCRIPTION OF THE DRAWINGS

The foregoing summary, a preferred embodiment, and other aspects of subject matter of the present disclosure will be best understood with reference to a detailed description of specific embodiments, which follows, when read in conjunction with the accompanying drawings, in which:

FIG. 1 illustrates a side view of a hopper car of a dump train having a conveyor system according to certain teachings of the present disclosure.

FIG. 2 illustrates an end view of the hopper car of the dump train.

FIG. 3A illustrates a perspective view of the disclosed conveyor system.

FIG. 3B illustrates a side view of the disclosed conveyor system.

FIG. 4A illustrates a detailed perspective view of a plow assembly of the disclosed conveyor system.

FIG. 4B illustrates a detailed side view of the plow assembly of the disclosed conveyor system.

FIG. 5 illustrates an end view of the disclosed conveyor system mounted atop hopper cars of a dump train.

FIG. 6 illustrates another side view of a hopper car of a dump train having the disclosed conveyor system.

FIG. 7 illustrates another detailed perspective view of the plow assembly of the disclosed conveyor system.

FIG. 8A illustrates another perspective view of the disclosed conveyor system showing material being plowed from the conveyor belt to the hopper of one of the cars.

FIG. 8B illustrates a detailed perspective view of the disclosed conveyor system showing material being plowed from the conveyor belt to the hopper of one of the cars.

FIG. 9 illustrates an end view of a hopper car of a dump train having an unloading conveyor system mounted underneath the hopper.

FIG. 10 illustrates a perspective view of an embodiment of a hopper car of a dump train having a gate system.

FIG. 11 illustrates the plow assembly of the disclosed conveyor system having a pneumatic cylinder.

While the disclosed conveyor system for loading the spoils from an undercutter to railcars of a dump train is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION

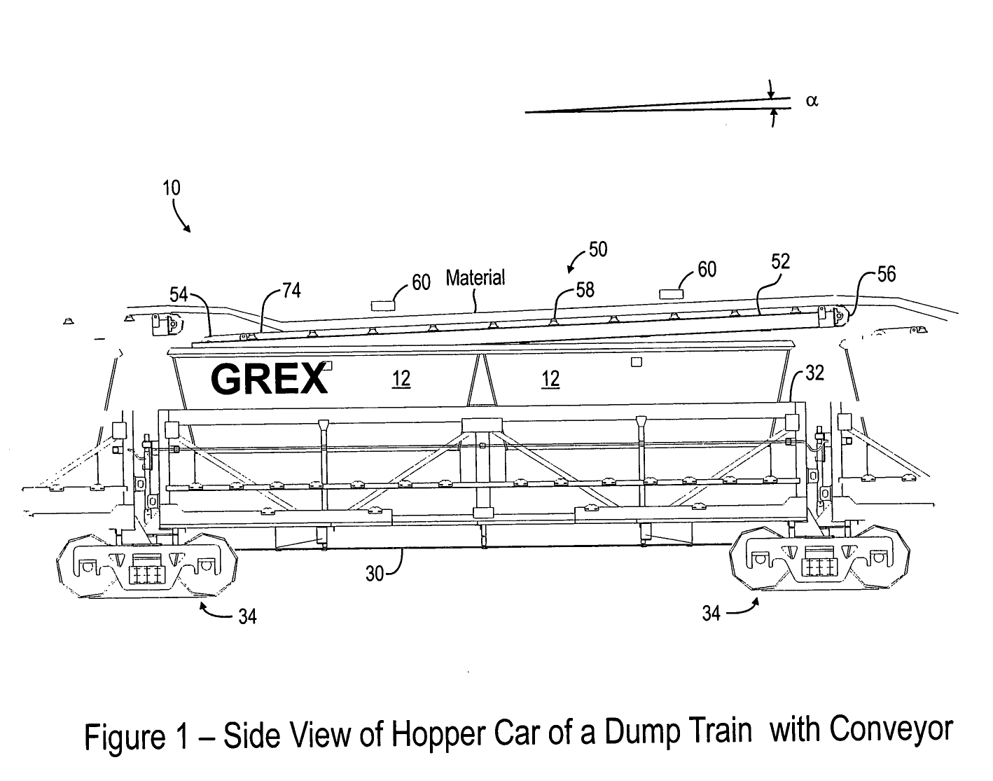

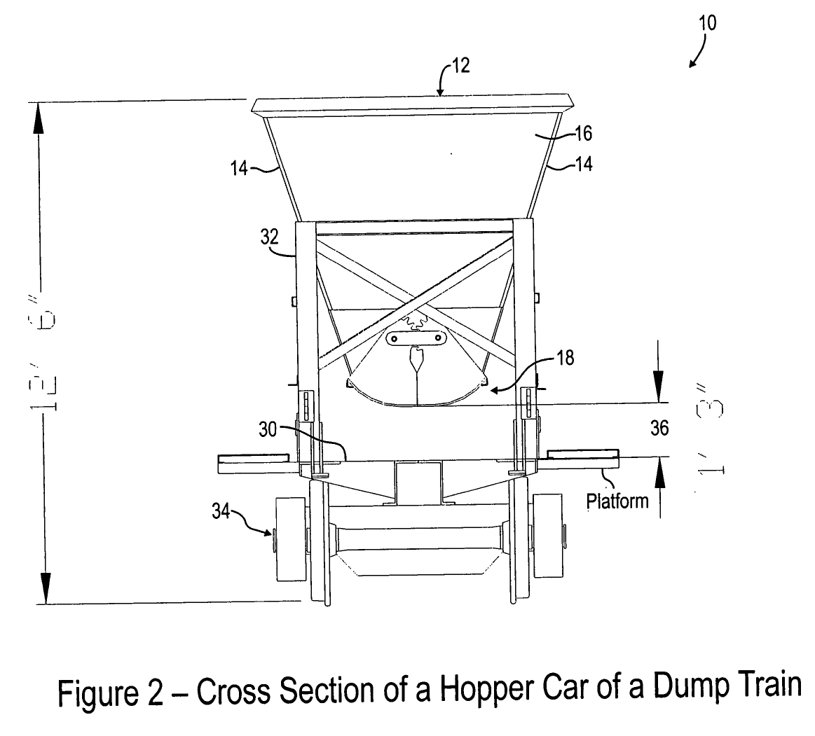

Referring to FIGS. 1 and 2, a hopper car 10 for a dump train is illustrated in an end view and a side view, respectively. In the side view of FIG. 1, the hopper car 10 of the dump train is shown having a conveyor system 50 according to certain teachings of the present disclosure. In the end view of FIG. 2, the hopper car 10 of the dump train is shown without the disclosed conveyor. Detailed description of a preferred hopper car 10 of a dump train for the disclosed conveyor system 50 is disclosed in U.S. Pat. No. 4,795,301 to Snead et al.; U.S. Pat. No. 4,925,356 to Snead et al.; U.S. Pat. No. 5,119,738 to Snead; and U.S. Pat. No. 5,197,845 to Snead, which are all incorporated herein by reference in their entireties. The hopper car 10 preferably has a 50-ton capacity. In addition, ten of the disclosed hopper cars 10 are preferably used to form a dump train having a total capacity of approximately 500-tons. Longer trains or shorter trains could be configured with a different number of similar 50-ton cars.

The hopper car 10 includes two hoppers 12, a base 30, a frame 32, and trucks 34. For example, the trucks 34 can have a single axle and can be the National Single Axle Unitruck II, manufactured by Midland Ross Corporation. Alternatively, the trucks 34 can be standard, two axle trucks, and the trains can use an ASF articulated coupler or can use slackless drawbars. As best seen in FIG. 2, the frame 32 supports the hopper 12 to the base 30. Each hopper 12 has an opened bottom with a gate system 18 for releasing material contained in the hopper 12. The gate system 18 is best shown in FIG. 2 and FIG. 10. Detailed description of a preferred gate system 18 for the hopper 12 is disclosed in the incorporated U.S. Pat. No. 5,119,738.

As best shown in FIG. 2, the base 30 of the hopper car 20 is formed from a center sill and side beam members that are supported on the trucks 34 in a conventional manner. While this particular form of railcar structure is illustrated, it will be understood that the hopper car may be constructed using other known techniques where the center sill is eliminated. The hopper 12 is generally rectangular, as viewed from the top. The hopper 12 has sidewalls 14 and end walls 16 that are inclined at shallow angles for discharging material from the hopper 12. The hopper 12 is supported by the frame 32 of the car 10. The frame 32 includes longitudinal channel stringers supported at the outer ends of the side beams of the base 30, which in turn support the vertical posts that bear on angle brackets suitably secured to the sidewalls 14 of the hopper 12.

The bottom of the hopper 12 is open for discharging material. The gate system 18 is mounted at the open bottom of the hopper 12. The gate system 18 includes a pair of co-acting gate members pivotally mounted for movement between opened and closed positions. Preferably, hydraulic actuators or cylinders (not shown) operate the gate system 10. Preferably, each gate of the gate system 18 would be powered by a hydraulic cylinder connected between the gate member and the sidewall 14 of the hopper. Preferably, the hydraulic cylinders are double-acting cylinders controlled by suitable four-way control valves. The control valves can be manual valves, for example, that are mounted on the hopper car 10 and that enable an operator to move along side the car and open the gate systems 18 for the several hoppers sequentially.

The hopper 12 is supported sufficiently high relative to the base 30 of the car 10 to provide space for an unloading conveyor system (not shown). As best shown in the end view of FIG. 2, the frame 32 is preferably constructed to provide an unobstructed channel 36 along the length of the hopper car 10. This unobstructed channel 36 accommodates the unloading conveyor system 40 between the gate system 18 and the base 30 of the hopper car 10. Detailed description of a preferred unloading conveyor system for the hopper car 10 is disclosed in the incorporated U.S. Pat. Nos. 4,795,301; 4,925,356; and 5,197,845. Typically, the channel 36 has a height of about 1-ft. and 3-inch.

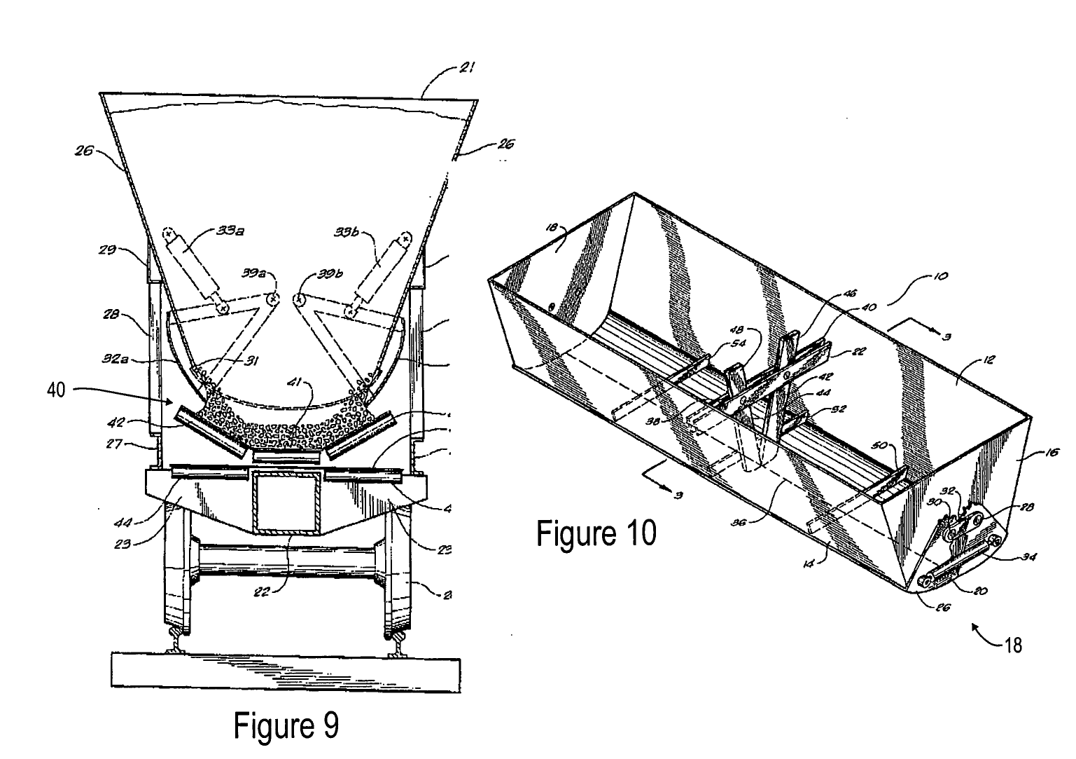

As described in the incorporated U.S. Pat. No. 4,795,301 and as shown in FIG. 9, for example, the unloading conveyor system 40 for unloading the dump train can be used in the channel 36 between the base 30 and the gate system 18. Briefly, the unloading conveyor system 40 has a continuous conveyor belt with a width substantially greater than that of the discharge opening of the hopper 12. For example, the conveyor belt can have a width approximately 33% greater than the discharge opening of the hopper 12. A supply belt or upper run of the continuous conveyor belt is supported in the form of a trough by troughing idlers. The return belt or return portion of the continuous belt is supported immediately under the supply belt by return idlers. The return idlers can be split idlers mounted on either side of the car center sill to support the return run as close as possible to the upper surface of the center sill. The troughing idlers are necessarily supported in catenary fashion to enable the positioning of the supply run as close as possible to the return run. With this belt support arrangement, the entire hopper car 10 will have the lowest possible center of gravity.

In contrast to the unloading conveyor system 40 described above, the loading conveyor system 50 of the present disclosure as shown in FIG. 1 is mounted atop the hopper cars 10. One conveyor system 50 is mounted on each hopper car 10 of the dump train, and the several conveyor systems 50 are used to load the hopper cars 10 of the dump train. The disclosed conveyor system 50 allows material to be conveyed forward over the tops of one or more of the hopper cars 10 of the dump train so that several cars 10 may be filled before car switching is necessary.

The conveyor system 50 includes a continuous conveyor belt 74 that rotates about a plurality of rollers 58 and end pulleys 54 and 56. To move material from one conveyor belt 74 to the next, each conveyor system 50 is set up on a slight incline V (approximately 9″ rise for a 32′ run) relative to the plane of the top of the car 10. The slight angle V allows material to jump an approximate one-foot gap between conveyor system 50 with minimal loss of material.

As noted in the Background Section of the present disclosure, the dump train having hopper cars 10 such as disclosed herein can be used to load the spoils of material from an undercutter, for example. The undercutter typically has a boom that discharges the spoils. The boom can be situated to discharge the spoils to the conveyor system 50 mounted atop the first hopper car 10 of the dump train. Preferably, a separate hopper is mounted above the conveyer system 50 on the first car 10 to initially receive the spoils from the boom. In addition, the first conveyor system 50 of the first car is preferably inclined at a greater angle than that of the other conveyor systems 50 on the other cars. From the first conveyor system 50, the subsequent conveyor systems 50 on the individual hopper cars 10 can convey the spoils along the cars 10 of the dump train for loading at selected hoppers 12 of the cars 10.

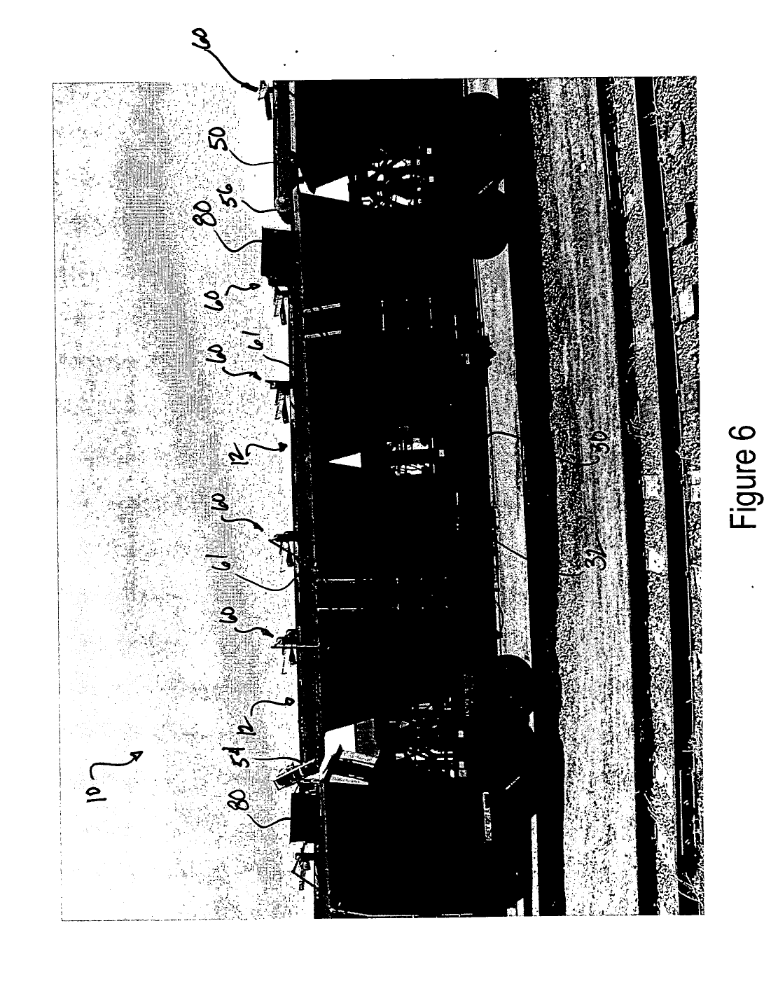

To screed material from the conveyor system 50 to the hoppers 12 of the cars 10, the conveyor system 50 has several plow assemblies 60 positioned at strategic points along the length of each conveyor system 50. Only two are schematically shown in FIG. 1 for illustrative purposes. As best shown in FIG. 6, however, four plow assemblies 60 are preferably provided on each hopper car 10 with two plow assemblies 60 mounted atop each hopper 12 of the car 10. The plows assemblies 60 can be raised or lowered either manually or under mechanical power to screed material off the continuous belt 74 and into the hoppers 12. With all the plow assemblies 60 positioned in a raised position on all of the conveyor systems 50 of the dump train, the material can be conveyed all the way forward along the dump train until the material reaches the end of the 10^{th} conveyor system 50 where it simply falls into the last hopper. As also shown in FIG. 6, each lower end of the conveyor system 50 can include a collecting bin 80 for preventing spilling of material as it moves from one conveyor system 50 to the next. The hopper cars 10 are necessarily very tall because the dump train must accommodate the unloading conveyor system 40 in the space 36 between the base 30 and gate system 18. As described above, the unloading conveyor 40 sits on top of the center sill (the main structural “spine” of the hopper car 10) of the frame 30. Consequently, the unloading conveyor system 40 takes up several inches of vertical space of the hopper car 10. In addition, the gates of the gate system 18 and the bottom of the hoppers 12 sit a considerable distance above the unloading conveyor assembly. This distance between the gates of the gate system 18 and the unloading conveyor assembly is necessary for the unobstructed passage of material on the unloading conveyor. Consequently, the bottom of the hoppers 12 are approximately 1-ft. 3-inch. above the center sill.

In contrast, the material container on nearly all other types of container cars other than a hopper car for a dump train can sit flush with the top of the center sill. In addition, the cross section of the hopper 12 for the dump train has a wedge shape. In contrast, nearly all other types of container cars have a rectangular cross section. Due to these different features of the hopper cars 10 for a dump train, the height of the hopper car 10 of the dump train must be high so that the hopper cars 10 can contain a considerable volume of material per linear foot of car length. Thus, the hopper cars 10 of the dump train may be much higher than other types of cars. As shown in FIG. 2, the hopper car 10 of the dump train can have a total height of approximately 12-ft. 6-inch. The design limit imposed by the railroads for Plate C total car height is 15-ft. 6-inch. This allows approximately 3-ft. of space above the hopper car 10 to fit the disclosed loading conveyor system 50 onto the top of the hopper car 10. To fit the disclosed loading conveyor system 50 in this 3-ft. space atop the hopper car 10, low profile C-channels 52 are used for the main structure of the conveyor's frame. The plow assemblies are designed to be as low as possible. In addition, a combination of other features of the disclosed conveyor system 50 allows it to fit into the 3-ft space, as will be apparent from the present disclosure.

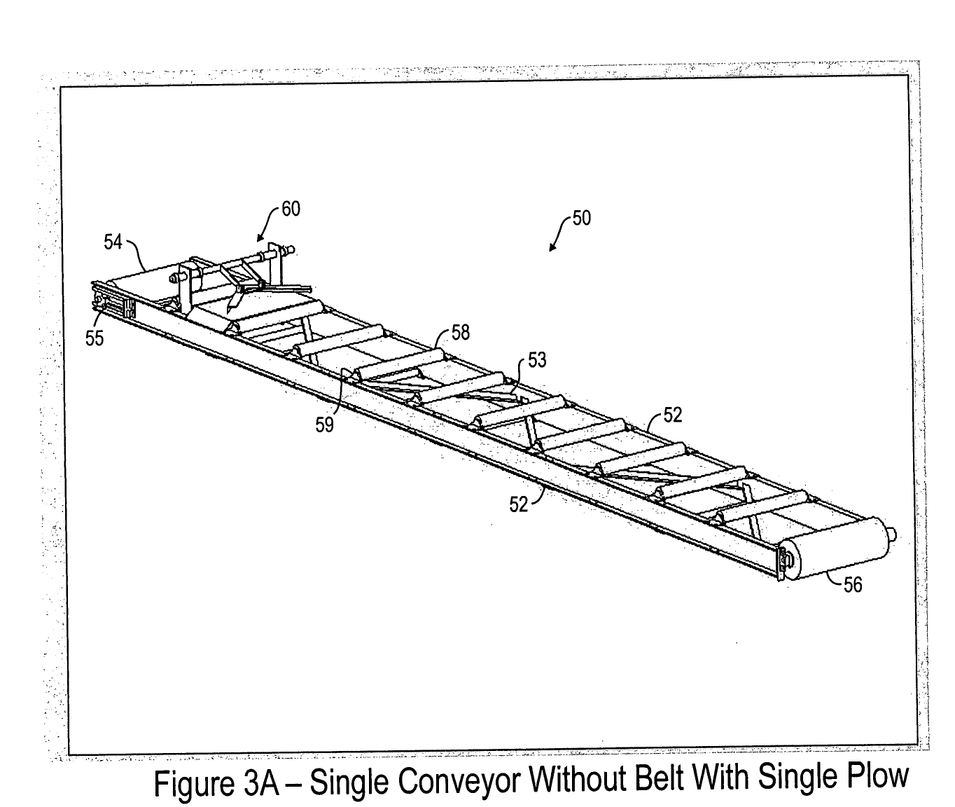

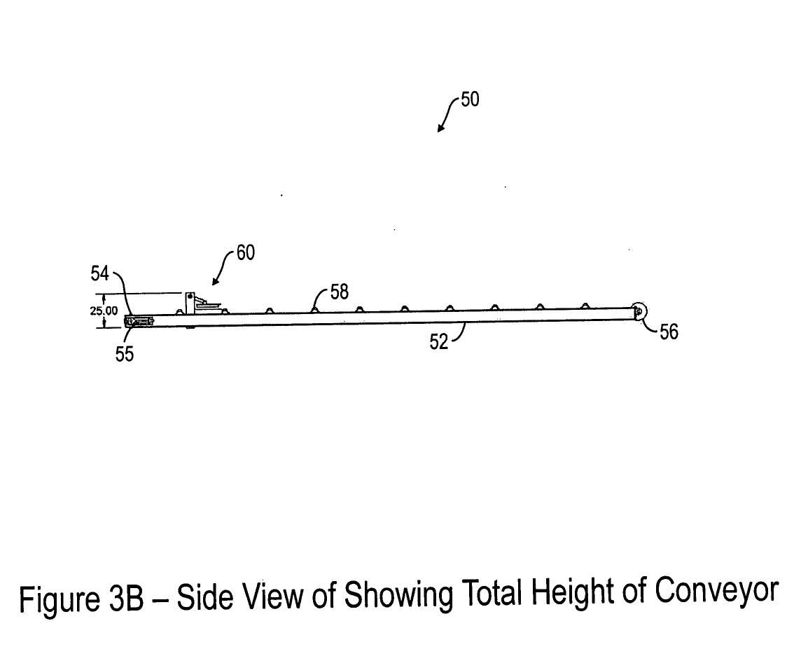

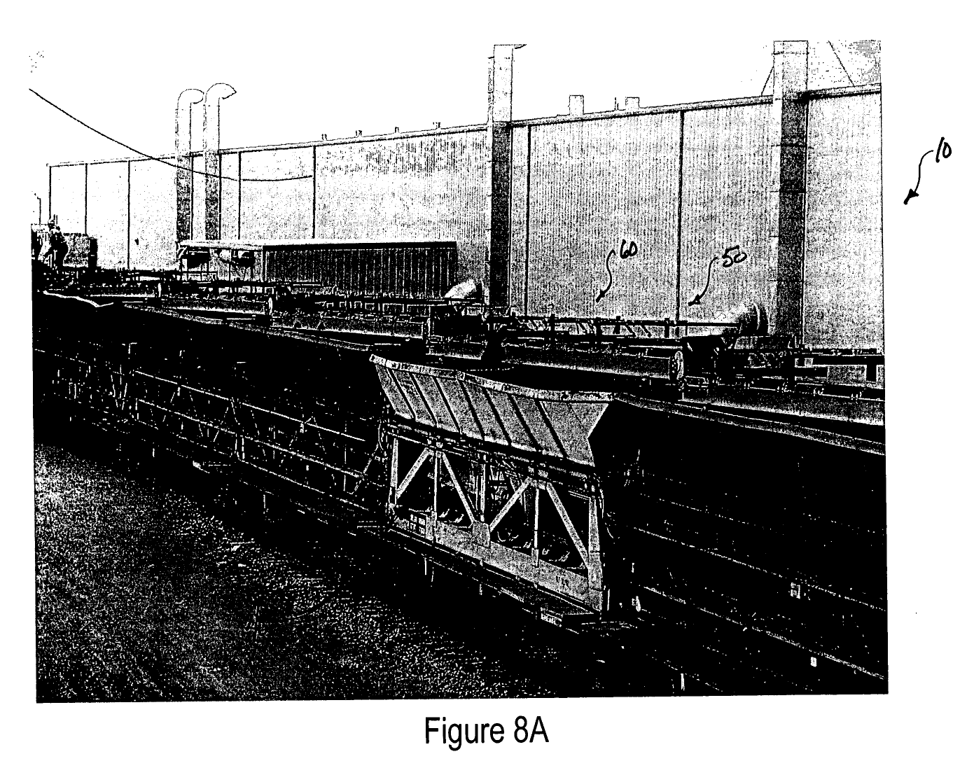

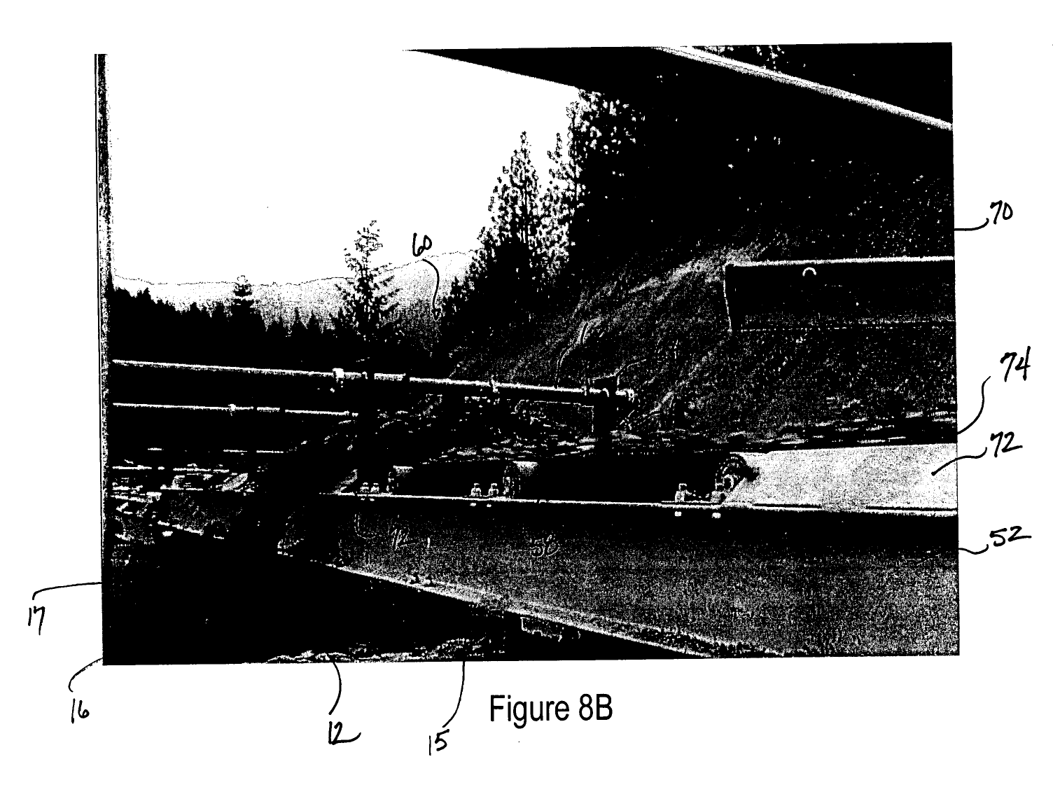

Referring to FIG. 3A-3B, the disclosed loading conveyor system 50 is illustrated by itself in a perspective view and a side view, respectively. The conveyor system 50 includes side frames 52 positioned parallel to one another and connected by cross supports 53. The side frames 52 are preferably low profile, C-channels and are connected by cross supports 53. The side frames 52 are bolted at one end to the top of the end wall 16 of one hopper 12 and are bolted at the other end to the top of the end wall 16 of the other hopper 12 of the car 10. FIG. 8B shows a bolted connection at 17 of the frames 52 to an end wall 16. The central portions of the side frames 52 can rest on a cross bar or the central divide of the hoppers 12 in the car 10. FIG. 8B shows such a support at 15.

As best shown in FIG. 3A, the side frames 52 have a lead pulley 54 attached at one end and have a trail pulley 56 attached at the other end. As best shown in FIG. 3A, the pulleys 54 and 56 are attached so that they fit between the side frames 52, which reduces the profile of the disclosed conveyor system 50. A plurality of idle rollers 58 are positioned along the length of the side frames 52. Side brackets 59 attach the ends of the idle rollers 58 to the side frames 52 so that the idle rollers 58 are positioned above the level of the side frames 52. A continuous belt 74, which is not shown in FIGS. 3A-3B but is shown in FIGS. 1 and 5-8B, is positioned about the conveyor system 50 so that the belt rolls around the pulleys 52 and 54, over the idle rollers 58, and under the conveyor system 50. A commercially available motor (not visible) is integrated into or housed within the body of the lead pulley 54. Preferably, the motorized, lead pulley 54 is a Rollerdrive manufactured by Interroll of Wilmington, N.C. The motorized pulley 54 moves the continuous belt around the conveyor system 50. Having the lead pulley 54 motorized by an internal motor provides a low profile to the conveyor system 50 and eliminates the need for a separate motor to be mounted on the conveyor system 50 or on hopper car 10, which could produce more vertical height than desired. The motorized pulleys 54 can be powered by a conventional generator. The side frames 52 have slots 55 where the lead pulley 54 is attached, which allows the position of the pulley 54 and the tension of the conveyor belt to be adjusted.

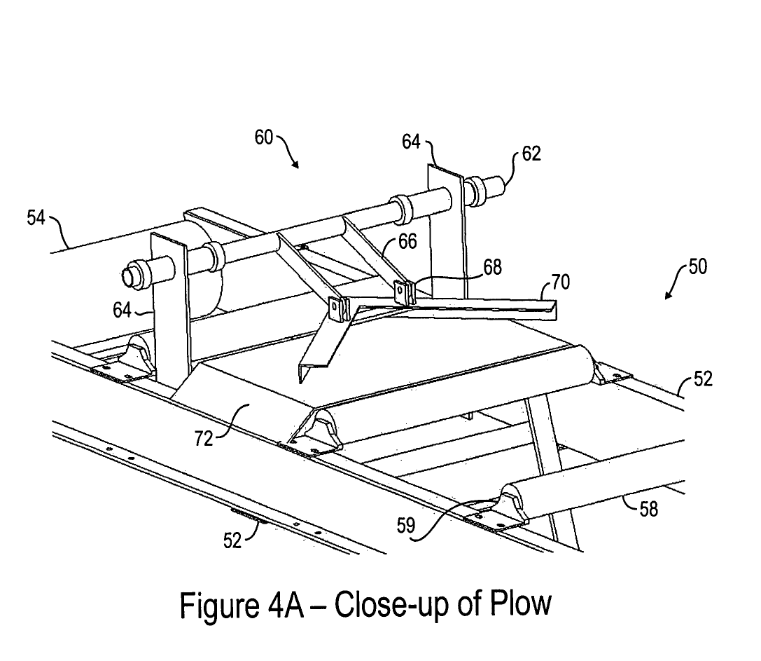

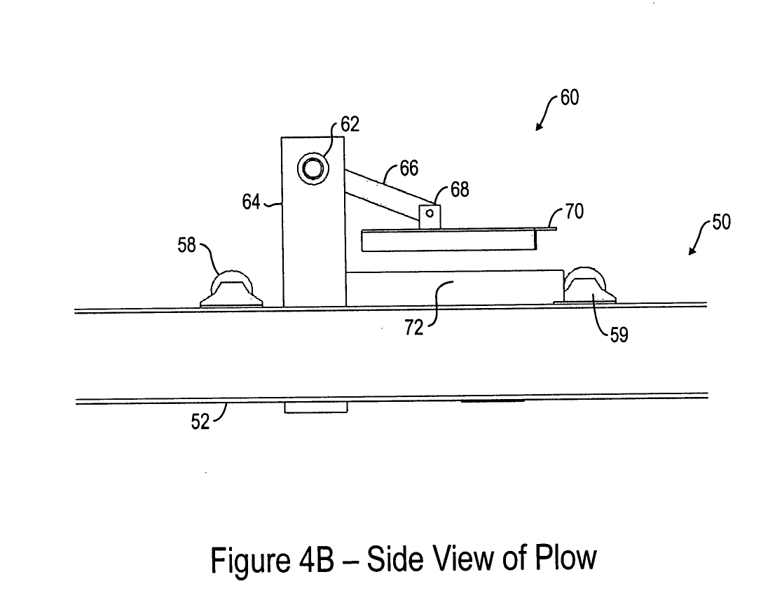

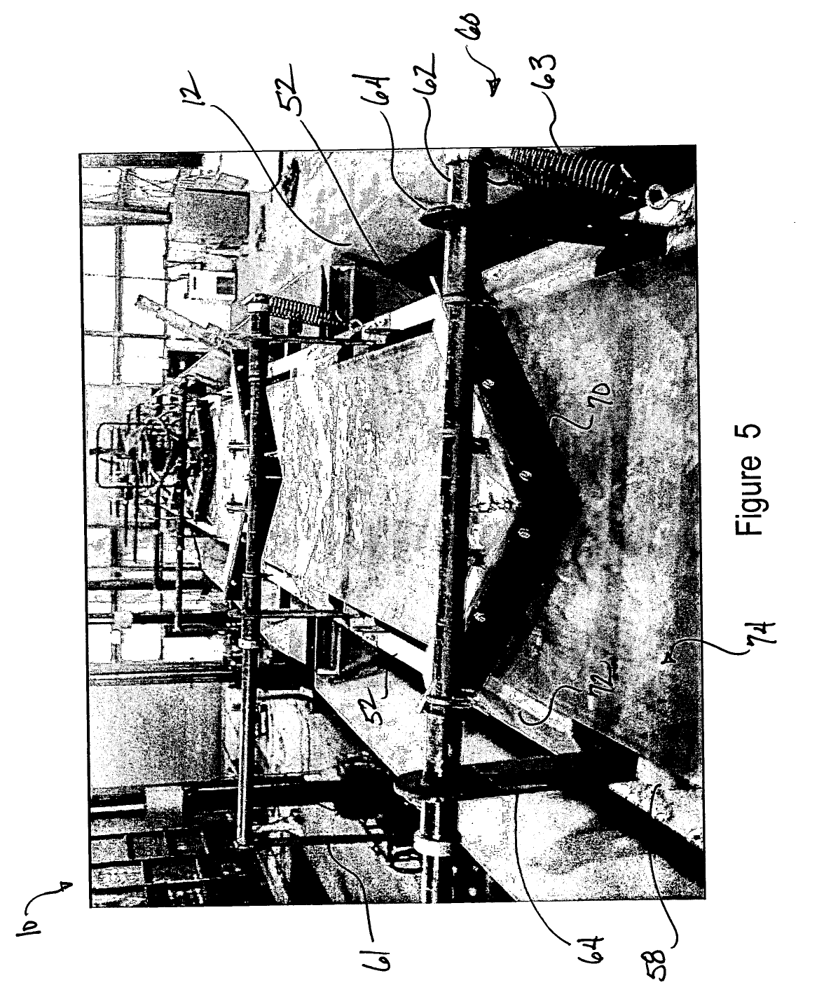

As discussed above, the conveyor system 50 includes a plurality of plow assemblies 60 positioned along the length of the conveyor system 50. Only one plow assembly is shown in FIGS. 3A-3B for illustrative purposes. FIGS. 4A-4B and 5 illustrate detailed views of the plow assembly 60 of the disclosed conveyor system 50. As best shown in FIG. 4A, the plow assembly 60 includes a rotatable rod 62 attached to the side frames 52 by supports 64, and the rotatable rod 62 is rotatable within the supports 64. Arms 66 attached to the rotatable rod 62 connect to a winged plow 70 with a joint 68. Rotation of the rotatable rod 62 moves the winged plow 70 up and down. When the winged plow 70 is up, the material on the conveyor belt (not shown) passes under the winged plow 70 as it is moved along the conveyor system 50. When the winged plow 70 is down, the winged plow 70 positions close to the conveyor belt (not shown) and screeds material that is moved along the conveyor off both sides of the conveyor. The tip of the winged plow 70 points against the flow direction of material when moved along the conveyor system 50. A support plate 72 is attached across the side frames 52 under the winged plow 70. The support plate 72 is flat, but includes slopped sides at the side frames 50 where material is allowed to slide off the conveyor belt when the winged plow 70 is down.

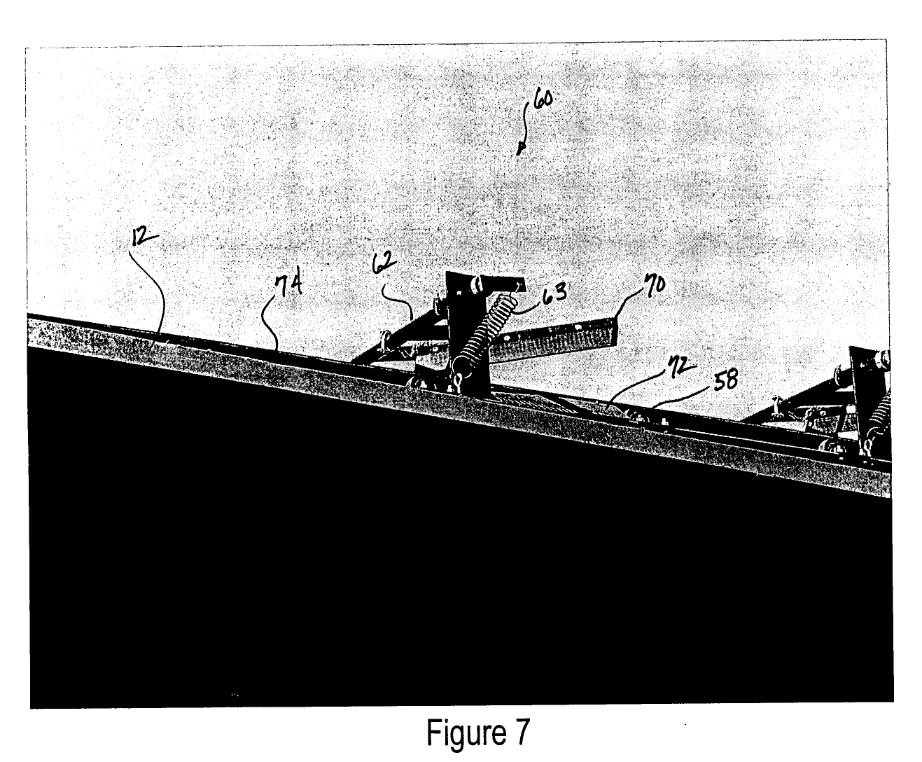

The various plow assemblies 60 can be operated to screed material into the various hopper cars along the length of the dump train. As shown in the side view of FIG. 6, two plow assemblies 60 are preferably provided for each hopper 12 of a hopper car 10 on the dump train so that the individual hoppers 12 can be sufficiently filled with material. In the embodiment shown in FIGS. 5 and 6, the plow assemblies 60 can be operated manually using a lever arm 61 to rotate the rotatable rod 62. For example, a worker may walk along the platforms along the side of the hopper cars 10 and can move the lever arms 61 of the plow assemblies 60. As shown in FIGS. 5 and 7, a spring 63 can be provided on the other end of the rotatable rod 62 to bias the winged plow 70 in the upward position. When the worker operates the plow assembly, the lever arm can be locked in place to keep the winged plow 70 in the downward position.

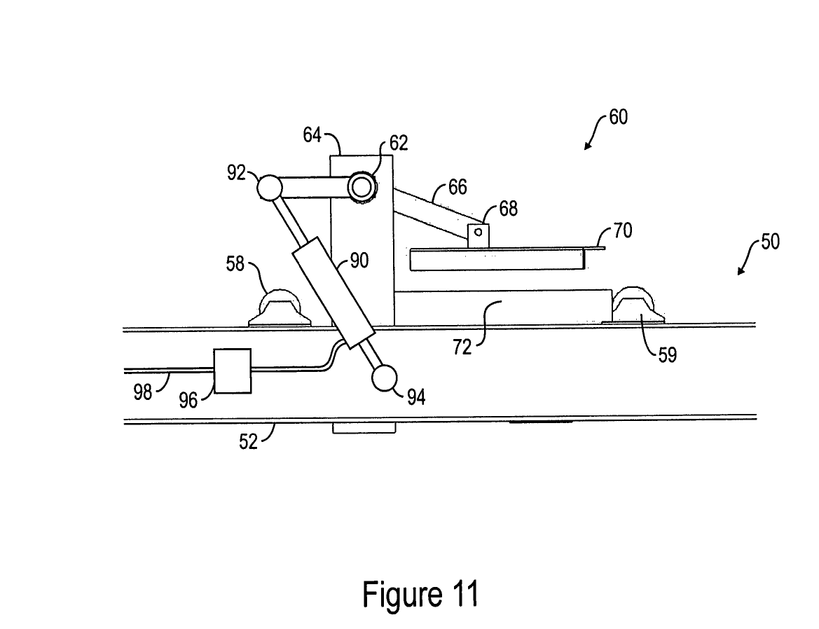

In another embodiment shown in FIG. 11, the plow assembly 60 can be operated automatically using a fluid actuator 90 in much the same way as the hopper doors of the hopper cars are operated. The fluid actuator 90 is preferably a pneumatic cylinder operated by pressurized air. One end 92 of the pneumatic cylinder 90 is coupled to the rotatable rod 62 of the plow assembly 60, and another end 94 can be coupled to the frame 52 of the conveyor system 50. An open/closed valve 96 connects a supply line 98 of pressurized air from a compressor to the pneumatic cylinder 90. In one state, the valve 96 prevents the supply of pressurized air to the cylinder 90 and allows the air in the cylinder 90 to vent to the atmosphere. The spring (not shown in FIG. 11) can bias the plow assembly 60 to the raised position. In another state, the valve 96 supplies the pressurized air to the cylinder 90 causing the cylinder 90 to actuate the plow assembly 60 and lower the winged plow 70 adjacent the conveyor belt (not shown). The pneumatic cylinder 90 is preferred because the compressed air in the cylinder 90 when activated allows the plow assembly 60 to give slightly if a large piece of debris is conveyed along the belt. Although not preferred, the fluid actuator 90 could also operate using hydraulic fluid.

FIG. 8A illustrates another perspective view of the disclosed conveyor system 50 showing material being plowed from the conveyor belt 74 to the hopper 12 of one of the cars 10. Four plow assemblies 60 are preferably provided for each conveyor system 50. FIG. 8B illustrates a detailed perspective view of the disclosed conveyor system 50 and plow assembly 60 showing material being plowed from the conveyor belt 74 to the hopper 12 of one of the cars 10.

As noted above, each plow assembly 60 includes a winged plow 72 and a rotatable rod 62. The rotatable rod 62 is operated by a lever 61 or pneumatic cylinder 90, and the winged plow 70 can be raised and lowered relative to the conveyor belt 74. The winged plow 70 is preferably balanced at joint 68 connecting it to the rotatable rod 62 so that the winged plow 70 can remain substantially level with the plane of the conveyor belt 74 when the winged plow 70 is raised or lowered. While the conveyor system 50 moves material, the winged plow 70 of a lowered plow assembly 60 forces material off the conveyor belt 74, causing the material to fall into the hopper 12 of the car 10. Preferably, the slanted portions of the support plates 72 positioned at the sides of the conveyor belt 74 where the material is forced off the belt 74 prevents material from dropping into a gap between the conveyor belt 74 and a side of the conveyor system 50. The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A hopper car of a dump train for transporting material, comprising:
an open hopper; and
a conveyor loading system for loading the hopper with the material, said system positioned longitudinally along the hopper car, the system including:
a frame attached to the car;
a continuous belt conveyor assembly supported by the frame in an elevated position over the open hopper, whereby the continuous belt conveyor assembly transports the material from one end of the hopper car to a second end; and
a plow assembly positioned adjacent the continuous belt conveyor assembly and selectively operable to screed material from the continuous belt conveyor assembly and into the open hopper.

2. The hopper car of claim 1, wherein one end of the conveyor assembly is elevated with respect to the opposed end of the conveyor assembly.

3. The hopper car of claim 1, wherein the frame comprises first and second parallel C-channels.

4. The hopper car of claim 1, wherein the belt conveyer assembly includes a plurality of idle rollers attached along the length of the frame for supporting the continuous belt.

5. The hopper car of claim 1, wherein the hopper car comprises two open hoppers and two plow assemblies, and a plow assembly is positioned on the frame above each of the two open hoppers.

6. The hopper car of claim 1, wherein the hopper car comprises multiple open hoppers and multiple plow assemblies wherein at least one plow assembly is positioned on the frame above each open hopper.

7. The hopper car of claim 1, wherein the plow assembly comprises:
a rotatable rod attached to the frame; and
a plow attached to the rotatable rod by an arm and a joint, whereby rotation of the rod raises or lowers the plow relative to the continuous belt conveyor assembly.

8. The hopper car of claim 7, wherein the plow has first and second wings.

9. The hopper car of claim 7, wherein the plow assembly further comprises a base plate attached to the frame and positioned beneath the plow.

10. The hopper car of claim 9, wherein the base plate has angled sides.

11. The hopper car of claim 1, wherein the plow assembly includes a lever for operating the plow assembly.

12. The hopper car of claim 1, wherein the plow assembly includes a pneumatic cylinder for operating the plow assembly.

13. The hopper car of claim 1, further comprising:
a gate mounted at an open bottom of the hopper and movable between an opened and a closed position for discharging material from the hopper; and
a second continuous belt conveyor system positioned underneath the gate for unloading the hopper and carrying the discharged material from one end of the hopper car to the second end.

14. A dump train for transporting material, comprising:
a plurality of hopper cars having hopper containers;
means for conveying the material above the hopper cars from a first end of the dump train to a selected hopper container; and
means for moving the material from the conveying means into the selected hopper container.

15. The dump train of claim 14, further comprising means for initially receiving the material on a first end of the conveying means from a boom to be conveyed above the dump train to the selected hopper container.

16. The dump train of claim 14, wherein the means for conveying the material above the top of the hopper cars further comprises means for providing individual power at each hopper car.

17. The dump train of claim 14, wherein the means for moving the material from the conveying means to the selected hopper is manually operated.

18. The dump train of claim 14, wherein the means for moving the material from the conveying means to the selected hopper is pneumatically operated.

19. The dump train of claim 14, further comprising:
means for emptying material from a hopper container; and
means for conveying the emptied material underneath the hopper cars to an end of the dump train.

20. A method of loading a plurality of hopper cars of a dump train with material, comprising:
conveying the material along conveyors individually mounted atop each of the hopper cars of the dump train;
transferring the material between the individual conveyors; and
individually filling hoppers of the hopper cars by selectively operating plows positioned above the conveyors to screed material off the conveyors and into the hoppers.

21. The method of claim 20, further comprising initially receiving the material on a first conveyor of the dump train from a boom.

22. The method of claim 20, wherein conveying the material along the conveyors individually mounted atop each of the hopper cars of the dump train comprises individually powering each conveyor with a separate motor.

23. The method of claim 20, wherein transferring the material between the individual conveyors comprises positioning the individual conveyors such that a first end of a conveyor is positioned higher than an end of an adjacent conveyor and a second end of the conveyor is positioned lower than an end of another adjacent conveyor.

24. The method of claim 20, wherein selectively operating the plows positioned above the conveyors to screed material off the conveyors and into the hoppers comprises manually operating levers on the plows to raise and lower them relative to the conveyors.

25. The method of claim 20, wherein selectively operating the plows positioned above the conveyors to screed material off the conveyors and into the hoppers comprises operating pneumatic cylinders coupled to the plows to raise and lower them relative to the conveyors.

26. The method of claim 20, further comprising:
emptying the material from the hoppers of the hopper cars by selectively operating gates mounted at open bottoms of the hoppers; and
conveying the emptied material along a continuous conveyor mounted underneath the hoppers of the dump train.
